(19) United States
(12) Patent Application Publication
(10) Pub. No.: US 2024/0294165 A1
(43) Pub. Date: Sep. 5, 2024

(54) CONCEPT FOR ASSISTING A MOTOR VEHICLE

(71) Applicant: Robert Bosch GmbH, Stuttgart (DE)

(72) Inventors: Andreas Lehn, Ostfildern (DE); Felix Hess, Benningen (DE)

(21) Appl. No.: 18/687,759

(22) PCT Filed: Dec. 5, 2022
(86) PCT No.: PCT/EP2022/084334

§ 371 Date: Feb. 28, 2024

(30) Foreign Application Priority Data
Dec. 9, 2021 (DE) 10 2021 214 055.6

(51) Int. Cl. B60W 30/06; H04W 4/44

(52) U.S. Cl. CPC B60W 30/06; H04W 4/44; B60W 2556/45

(57) ABSTRACT

A system for infrastructure-based assistance of a motor vehicle guided in an at least partially automated manner within a parking lot. The system includes: first and second base units arranged spaced apart from one another within the parking lot and interconnected in series. The first and second base units are respectively connected to at least one environment sensor that is arranged within the parking lot, in the respective environment of the corresponding base unit, and detects an area of the parking lot. The first and second base units are respectively configured to ascertain infrastructure assistance data for infrastructure-based assistance of the motor vehicle within the parking lot, based on environment sensor data of the respective at least one environment sensor that represent the respective detected area. At least one wireless communication interface is configured to transmit the ascertained infrastructure assistance data to the motor vehicle.

### FIELD

The present invention relates to a system for infrastructure-based assistance of a motor vehicle guided in an at least partially automated manner within a parking lot, to a method for infrastructure-based assistance of a motor vehicle guided in an at least partially automated manner within a parking lot, to a computer program, and to a machine-readable storage medium.

### BACKGROUND INFORMATION

“AVP” stands for “automated valet parking” and can be translated into German as “Automatischer Parkservice” (automated parking service).

Parking lots that can provide an AVP functionality for a motor vehicle comprise several environment sensors, which respectively detect an area of the parking lot. The environment sensor data corresponding to the detection are transmitted from the environment sensors to a central server, which evaluates the environment sensor data and, on the basis of the evaluation, ascertains infrastructure assistance data on the basis of which the motor vehicle can be guided in an at least partially automated manner within the parking lot. Such infrastructure assistance data can be transmitted to the motor vehicle wirelessly, for example via a WLAN.

German Patent Application No. DE 10 2016 223 830 A1 describes a method for operating an automated vehicle.

PCT Patent Application No. WO 2018/029101 A1 describes a controller of an autonomous vehicle.

U.S. Patent Application Publication No. US 2019/0132709 A1 describes a sensor network.

### SUMMARY

An object of the present invention is to provide for efficient, infrastructure-based assistance of a motor vehicle guided in an at least partially automated manner within a parking lot.

This object may be achieved by means of features of the present invention. Advantageous embodiments of the present invention are disclosed herein.

According to a first aspect of the present invention, a system for infrastructure-based assistance of a motor vehicle guided in an at least partially automated manner within a parking lot is provided. According to an example embodiment of the present invention, the system comprises:
a first base unit and a second base unit, which are arranged spaced apart from one another within the parking lot and are interconnected in series,
wherein the first base unit and the second base unit are respectively connected to at least one environment sensor that is arranged within the parking lot, in the respective environment of the corresponding base unit, and detects an area of the parking lot,
wherein the first and second base units are respectively configured to ascertain infrastructure assistance data for infrastructure-based assistance of the motor vehicle guided in an at least partially automated manner within the parking lot, on the basis of environment sensor data of the respective at least one environment sensor that represent the respective detected area,
at least one wireless communication interface which is configured to transmit the ascertained infrastructure assistance data to the motor vehicle.

According to a second aspect of the present invention, a method for infrastructure-based assistance of a motor vehicle guided in an at least partially automated manner within a parking lot, using the system according to the first aspect of the present invention, is provided. According to an example embodiment of the present invention, the method comprises the following steps: ascertaining, by means of at least one of the first and second base units, infrastructure assistance data for infrastructure-based assistance of the motor vehicle guided in an at least partially automated manner within the parking lot, on the basis of the corresponding environment sensor data, transmitting the ascertained infrastructure assistance data to the motor vehicle by means of the at least one wireless communication interface.

According to a third aspect of the present invention, a computer program is provided, which comprises instructions that, when the computer program is executed by a computer, e.g., by the system according to the first aspect of the present invention, cause the latter to carry out a method according to the second aspect of the present invention.

According to a fourth aspect of the present invention, a machine-readable storage medium is provided, in which the computer program according to the third aspect of the present invention is stored.

The present invention is based on and includes the knowledge that the above object is achieved by the system being implemented as an edge computing architecture. In contrast to cloud computing, edge computing refers to decentralized data processing at the edge of a network. That is to say, according to example embodiments of the present invention described herein, it is provided that the ascertainment of the infrastructure assistance data is no longer left to a central server but is carried out by several base units arranged within the parking lot. Thus, a transmission path between the environment sensor and the instance that ascertains the infrastructure assistance data on the basis of the environment sensor data, in the present case the base unit, is advantageously shortened in comparison to the central server, which is generally arranged in a server room, which is usually located outside the parking lot.

Furthermore, according to an example embodiment of the present invention described herein, it is provided that, in order to ascertain the infrastructure assistance data, the base unit does not use the environment sensor data of all environment sensors arranged within the parking lot, but only a subset of, e.g., 4 to 16, environment sensors. Thus, the base units are only connected to the environment sensors that are located in the respective environment of the base units. This, too, can advantageously efficiently reduce a transmission path in comparison to the approach comprising the central server, which receives the corresponding environment sensor data from all environment sensors of the parking lot.

This furthermore brings about a technical advantage that an effort for laying data cables for the purpose of transmitting the environment sensor data can be efficiently reduced.

This furthermore brings about a technical advantage that a required minimum bandwidth for data transmission of the environment sensor data can be efficiently reduced since fewer environment sensor data must be transmitted to a single base unit in comparison to the approach with the central server.

This furthermore brings about a technical advantage that, in comparison to a central server, the base units can be equipped with less hardware since they do not have to process the same amount of environment sensor data in comparison to the central server.

This furthermore brings about a technical advantage that a central server can be dispensed with. This furthermore brings about the technical advantage that a separate server room can be dispensed with. Thus, costs and installation space for such a server room can be saved.

The example embodiments of the present invention described herein provides that directly adjacent base units are interconnected. In English, the term “daisy chain” is used for such a topology. That is to say, the base units are connected in series. This in particular has the technical advantage that the base units can respectively receive the environment sensor data of the at least one environment sensor connected to the other base unit, from directly adjacent base units. This is to be considered in contrast to a tree topology, which is commonly used in the approach with the central server. In comparison to a tree topology, a daisy chain reduces an effort for laying data cables for the purpose of transmitting the environment sensor data.

Furthermore, example embodiments of the present invention may have the technical advantage that a complexity of the hardware products used can be reduced in comparison to the central server approach since it requires two types of hardware: base unit and environment sensor.

This provides for efficient, infrastructure-based assistance of a motor vehicle guided in an at least partially automated manner within a parking lot.

In particular, the term “infrastructure-based assistance of a motor vehicle” means that infrastructure assistance data are provided to the motor vehicle. The motor vehicle can, for example, derive instructions for action on the basis of the infrastructure assistance data. For example, on the basis of the infrastructure assistance data, the motor vehicle itself can decide what to do.

Infrastructure assistance data, for example, include one or more of the following data elements: control command for the at least partially automated control of a lateral and/or longitudinal guidance of the motor vehicle, remote control command for the at least partially automated, remote control of a lateral and/or longitudinal guidance of the motor vehicle, release command for releasing an at least partially automated, in particular fully automated, trip of the motor vehicle for a particular time in a particular area of the parking lot, desired trajectory for the motor vehicle, target location within the parking lot, environmental data representing an environment of the motor vehicle, specification as to what the motor vehicle should do.

The specification, for example, specifies whether the motor vehicle may, for example, drive or must, for example, stop. The formulation “in one embodiment of the system” as used in this description includes the formulation “in one embodiment of the system, wherein the embodiment, for example, comprises the respective features of at least one of the embodiments described in the description.” That is to say, the respective features of the embodiments described in the description may, for example, be in any combination.

In one embodiment of the system of the present invention, it is provided that the first and second base units are respectively configured to ascertain the infrastructure assistance data on the basis of the environment sensor data of the at least one environment sensor of the respectively other base unit.

This, for example, brings about the technical advantage that the infrastructure assistance data can be ascertained efficiently. The environment sensor data of the at least one environment sensor of the respectively other base unit are, for example, requested by means of the first or the second base unit, from the respectively other base unit.

In order to ascertain a release for driving for the motor vehicle, it is advantageous if the entire environment of the motor vehicle is known. Thus, if the environment sensors connected to the base unit do not detect the entire environment, it is provided according to one embodiment that the environment sensor data of the environment sensors there are used by the adjacent base unit(s).

A great advantage is: The arrangement of the environment sensors and/or of the base units is such that at most the environment sensor data of the directly adjacent base unit(s) are needed. Information from base units that are further away is not generally needed.

In one embodiment of the present invention, it is provided that the first and second base units respectively comprise a first communication device, in particular a first network switch, and a second communication device, in particular a second network switch, wherein the connection between the first and second base units is formed using the two first communication devices, and wherein the respective connection between the at least one environment sensor and the corresponding base unit is formed using the corresponding second communication device.

This means that the first communication device is or comprises a first network switch, for example. This means that the second communication device is or comprises a second network switch, for example.

In this respect, according to one embodiment of the system of the present invention, it may be provided that the first and second base units respectively comprise a first network switch and a second network switch, wherein the connection between the first and second base units is formed using the two first network switches, and wherein the respective connection between the at least one environment sensor and the corresponding base unit is formed using the corresponding second network switch.

This, for example, brings about the technical advantage that the first and second base units and/or the respective at least one environment sensor and the corresponding base unit can be efficiently interconnected.

In one embodiment of the system of the present invention, it is provided that the first and second base units are arranged along a driving path of the parking lot.

This, for example, brings about the technical advantage that a communication path between the base units and the motor vehicle to be assisted can be kept as short as possible.

In one embodiment of the system of the present invention, it is provided that the first and second base units are configured to track the motor vehicle on the basis of the environment sensor data and to control, on the basis of the tracking, the respective transmission of infrastructure data by means of the corresponding wireless communication interface.

This, for example, brings about the technical advantage that the transmission of infrastructure data can be controlled efficiently. Controlling the transmission, for example, comprises ending the transmission and, for example, transferring the transmission to a directly adjacent base unit that is in the driving direction of the motor vehicle. Tracking the motor vehicle, for example, comprises ascertaining a position of the motor vehicle. Tracking the motor vehicle, for example, comprises ascertaining a distance of the motor vehicle relative to a predetermined fixed position. The predetermined fixed position is, for example, the position of the first or second base unit.

It is, for example, such that each base unit knows its adjacent base units. It thus knows that, if the motor vehicle, for example, drives north, it must transfer to the base unit to the north; if the motor vehicle, for example, drives south, it must transfer to the south base unit. This information as to where which adjacent base units are arranged, is respectively stored in a memory of the base units, for example.

In one embodiment of the system of the present invention, the system comprises a third base unit, which is arranged within the parking lot and connected in series to the first or the second base unit, wherein the third base unit is connected to at least one environment sensor, which is arranged within the parking lot, in the environment of the third base unit, and detects an area of the parking lot, wherein the third base unit is configured to ascertain infrastructure assistance data for infrastructure-based assistance of the motor vehicle guided in an at least partially automated manner within the parking lot, on the basis of the environment sensor data of the at least one environment sensor that represent the respective detected area, wherein the third base unit comprises a wireless communication interface, which is configured to transmit the infrastructure assistance data to the motor vehicle.

This, for example, brings about a technical advantage that the motor vehicle can be assisted efficiently. Statements made in connection with the first and/or the second base unit apply analogously to the third base unit, and vice versa.

An environment sensor within the meaning of the description is, for example, one of the following environment sensors: radar sensor, lidar sensor, ultrasonic sensor, video sensor/camera (both mono and stereo camera), magnetic field sensor, and infrared sensor.

In one embodiment of the method according to the second aspect of the present invention, it is provided that the method is a computer-implemented method.

Technical functionalities of the method according to the second aspect result from corresponding technical functionalities of the system according to the first aspect, and vice versa.

That is to say, method features result from system features, and vice versa.

The phrase “at least partially automated guidance” includes one or more of the following cases: assisted guidance, partially automated guidance, highly automated guidance, fully automated guidance.

Assisted guidance means that a driver of the motor vehicle permanently performs either the lateral or the longitudinal guidance of the motor vehicle. The respectively other driving task (i.e., controlling the longitudinal or the lateral guidance of the motor vehicle) is carried out automatically. That is to say, in an assisted guidance of the motor vehicle, either the lateral guidance or the longitudinal guidance is controlled automatically.

Partially automated guidance means that, in a specific situation (for example: driving on a highway, driving within a parking lot, overtaking an object, driving within a lane defined by lane markings) and/or for a certain period of time, longitudinal and lateral guidance of the motor vehicle is automatically controlled. A driver of the motor vehicle does not have to manually control the longitudinal and lateral guidance of the motor vehicle. However, the driver has to continuously monitor the automatic control of the longitudinal and lateral guidance in order to be able to manually intervene if necessary. The driver must be ready at all times to fully take over motor vehicle guidance.

Highly automated guidance means that, for a certain period of time in a specific situation (for example: driving on a highway, driving within a parking lot, overtaking an object, driving within a lane defined by lane markings), longitudinal guidance and lateral guidance of the motor vehicle are controlled automatically. A driver of the motor vehicle does not have to manually control the longitudinal and lateral guidance of the motor vehicle. The driver does not have to continuously monitor the automatic control of the longitudinal and lateral guidance in order to be able to intervene manually if necessary. If necessary, a take-over request is automatically issued, in particular issued with a sufficient time reserve, to the driver to take over control of the longitudinal and lateral guidance. The driver therefore has to potentially be able to take over the control of the longitudinal and lateral guidance. Limits of the automatic control of the lateral and longitudinal guidance are recognized automatically. In highly automated guidance, it is not possible to automatically bring about a minimal risk state in every initial situation.

Fully automated guidance means that, in a specific situation (for example: driving on a freeway, driving within a parking lot, passing an object, driving within a travel lane defined by lane markings), longitudinal guidance and lateral guidance of the motor vehicle are controlled automatically. A driver of the motor vehicle does not have to manually control the longitudinal and lateral guidance of the motor vehicle. The driver does not have to monitor the automatic control of the longitudinal and lateral guidance in order to be able to intervene manually if necessary. Before the automatic control of the lateral and longitudinal guidance is ended, the driver is automatically requested to take over the driving task (control of the lateral and longitudinal guidance of the motor vehicle), in particular with a sufficient time reserve. If the driver does not take over the driving task, a return to a minimal risk state takes place automatically. Limits of the automatic control of the lateral and longitudinal guidance are recognized automatically. In all situations, it is possible to automatically return to a minimal risk system state. In the case of AVP, this may be fully automated guidance, wherein the driver no longer even needs to be in the motor vehicle. The motor vehicle can actually drive in a driverless fashion.

The terms “assist” and “support” may be used synonymously.

The abbreviation “at least one” means “one or more.”

The motor vehicle is, for example, configured to be guided in an at least partially automated manner. The motor vehicle is, for example, an AVP motor vehicle. Such a motor vehicle is in particular configured to perform an AVP operation. “AVP” stands for “automated valet parking” and can be translated into German as “Automatischer Parkservice” (automated parking service).

In one embodiment of the system of the present invention, it is provided that the at least one wireless communication interface is comprised by at least one base unit in each case.

This, for example, brings about the technical advantage that the wireless communication interface can be implemented efficiently.

At this point, it is noted that not every base unit must have a wireless communication interface. A base unit without a wireless communication interface can, for example, communicate by means of the wireless communication interface of the adjacent base unit, i.e., can transmit the infrastructure assistance data to the motor vehicle by means of the wireless communication interface of the adjacent base unit.

According to one embodiment of the system of the present invention, it is provided that each base unit has its own wireless communication interface.

According to one embodiment of the system of the present invention, it is provided that only some of the base units respectively have their own wireless communication interface.

When the description describes an exemplary system in which each of the base units respectively has its own wireless communication interface, the corresponding statements also apply to a system in which only some of the base units respectively have their own wireless communication interface.

A wireless communication interface within the meaning of the description is, for example, arranged separately from the base units within the parking lot. For example, one or more base units respectively comprise their own wireless communication interface. For example, one or more base units do not respectively comprise their own wireless communication interface, i.e., these base units are free from their own wireless communication interface. For example, one or more wireless communication interfaces are arranged separately from the base units within the parking lot, e.g., are mounted on a ceiling and/or on a pillar and/or on a wall. A base unit without its own wireless communication interface may, for example, use such a wireless communication interface to communicate with the motor vehicle, i.e., to transmit the infrastructure assistance data to the motor vehicle.

A wireless communication interface within the meaning of the description is, for example, arranged within the parking lot.

Exemplary embodiments of the present invention are illustrated in the figures and explained in more detail in the following description.

### BRIEF DESCRIPTION OF THE DRAWINGS

FIG. 1 shows a first system according to the first aspect of the present invention.

FIG. 2 shows a second system according to the first aspect of the present invention.

FIG. 3 shows a flow chart of a method according to the second aspect of the present invention.

FIG. 4 shows a machine-readable storage medium according to the fourth aspect of the present invention.

### DETAILED DESCRIPTION OF EXAMPLE EMBODIMENTS

In the following, identical reference signs can be used for identical features.

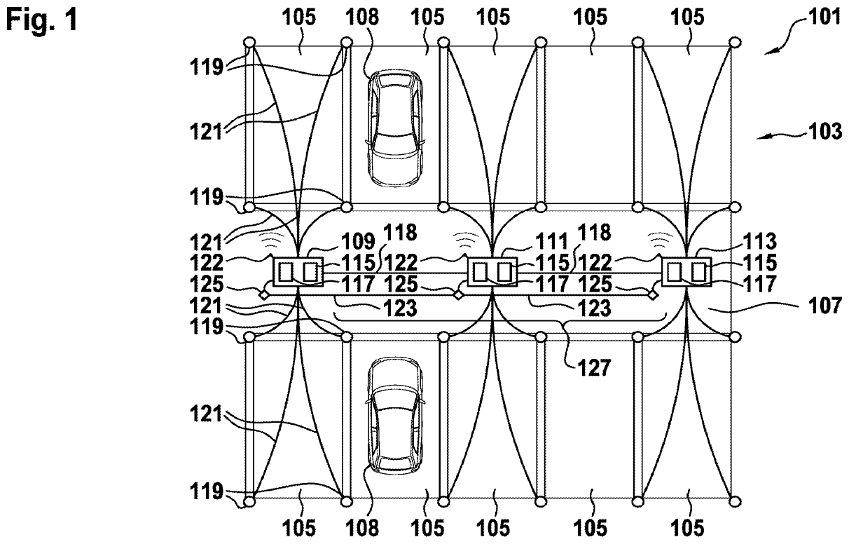

FIG. 1 shows a schematic plan view of a first system 101 for infrastructure-based assistance of a motor vehicle guided in an at least partially automated manner within a parking lot. The first system 101 is installed within a first parking lot 103. The parking lot 103 comprises several parking spaces 105 for motor vehicles and a roadway 107 for motor vehicles that defines a driving path for motor vehicles. The parking spaces 105 are arranged transversely to the driving path 107: 5 parking spaces 105 above the driving path 107 and 5 parking spaces 105 below the roadway 107 in relation to the plane of the paper. By way of example, two motor vehicles 108 are shown, wherein the one motor vehicle 108 is parked in the second, upper parking space 105 from the left, and wherein the other motor vehicle 108 is parked in the second, lower parking space 105 from the left.

The system 101 comprises a first base unit 109, a second base unit 111, and a third base unit 113, which are arranged along the driving path 107, e.g., on a ceiling (not shown) of the parking lot 103. The three base units 109, 111, 113 respectively comprise a first network switch 115 and a second network switch 117.

Using the corresponding first network switches 115, the first base unit 109 is connected in series to the second base unit 111 and the second base unit 111 is connected in series to the third base unit 113. A respective connection between the base units 109, 111, 113 is shown by means of a line with reference sign 118. For example, the respective connection 118 is an Ethernet connection.

Using the corresponding second network switches 117, the three base units 109, 111, 113 are respectively connected to environment sensors 119 arranged within the respective environment of the three base units 109, 111, 113 within the parking lot 103. The environment sensors 119 are comprised by the first system 101. Respective connections between the base units 109, 111, 113 and the environment sensors 119 are denoted by lines with reference sign 121, wherein, for the sake of clarity, only the corresponding lines for the first base unit 109 are provided with reference sign 121.

It is provided that the individual base units 109, 111, 113 are not connected to all environment sensors 119 located within the parking lot, but only to those in their immediate environment. Thus, it is provided by way of example that an environment sensor 119 is arranged at each corner of the parking spaces 105. The three base units 109, 111, 113 are respectively connected to 4 respective environment sensors of an upper and a lower parking space 105, i.e., in the present case, to a total of 8 environment sensors 119.

The environment sensors 119 respectively detect an area of the parking lot 103 and transmit environment sensor data corresponding to the detection, to the corresponding base units 109, 111, 113. On the basis of the environment sensor data, the corresponding base units 109, 111, 113 ascertain infrastructure assistance data.

The three base units 109, 111, 113 respectively comprise a wireless communication interface 122, by means of which they wirelessly transmit the infrastructure assistance data to a motor vehicle.

In one embodiment not shown, the first system 101 comprises one or more wireless communication interfaces, which are arranged separately from the base units 109, 111, 113 within the parking lot 103.

Furthermore, the three base units 109, 111, 113 are supplied with electrical energy via an electrical line 123. It is provided that the three base units 109, 111, 113 are respectively electrically connected to the electrical line 123 via an electrical connection 125. The electrical connection 125 is, for example, a socket or a distributor box, from which an electrical cable leads to the corresponding base unit in each case.

By interconnecting the three base units 109, 111, 113 in series, they form a daisy chain, which is symbolically denoted by a curly bracket with reference sign 127.

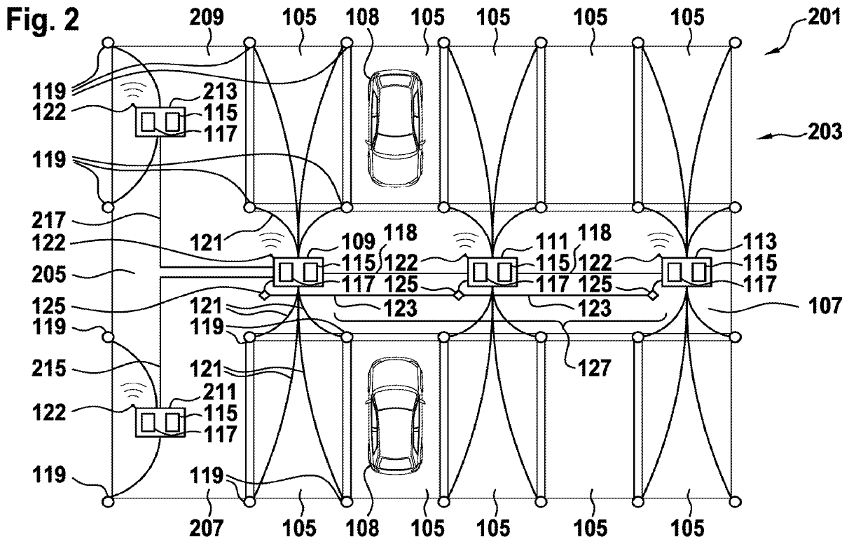

FIG. 2 shows a schematic plan view of a second system 201 for infrastructure-based assistance of a motor vehicle guided in an at least partially automated manner within a parking lot. The second system 201 is installed within a second parking lot 203. The second system 201 and the second parking lot 203 comprise the respective features of the first system 101 and of the first parking lot 103. A repeated description is therefore dispensed with. The additional features are described below.

The roadway 107 merges into a further roadway 205, which defines a further driving path for motor vehicles. In relation to the plane of the paper, the roadway 107 merges from the right into the further roadway 205, which is consequently located to the left of the roadway 107 in relation to the plane of the paper. In relation to the plane of the paper, the further roadway 205 extends from the bottom to the top and connects an entrance 207 to an exit 209 of the second parking lot 203.

Between the junction and the entrance 207, a fourth base unit 211 is arranged along the further roadway 205, e.g., on a ceiling of the second parking lot 203. Between the junction and the exit 209, a fifth base unit 213 is arranged along the further roadway 205, e.g., on a ceiling of the second parking lot 203.

The fourth and fifth base units 211, 213 are identical to the three base units 109, 111, 113 of the first system 101. The fourth base unit 211 is connected in series to the first base unit 109 by means of the respective first network switch 115. The corresponding connection is denoted by a line with reference sign 215. The fifth base unit 213 is connected in series to the first base unit by means of the respective first network switch 115. The corresponding connection is denoted by a line with reference sign 217. The connections 215, 217 are, for example, Ethernet connections.

The daisy chain 127 thus splits into two sub-branches: the connection 215 and the connection 217.

Not shown, but nonetheless present, is a splitting of the electrical line for the purpose of supplying the fourth and fifth base units 211, 213 with electrical energy.

Analogously to the three base units 109, 111, 113, the base units 211, 213 are also not connected to all the environment sensors 119 located within the second parking lot 203. Rather, the fourth base unit 211 is connected to two environment sensors 119 by means of the corresponding second network switch 117 and the fifth base unit 213 is connected to two environment sensors 119 by means of the corresponding second network switch 117, wherein these environment sensors 119 are located in the immediate environment of the two base units 211, 213.

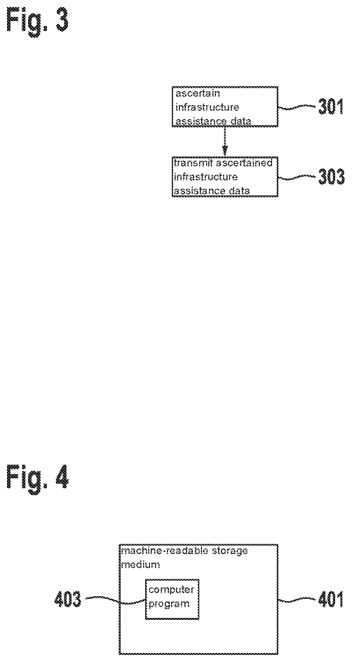

FIG. 3 shows a flow chart of a method for infrastructure-based assistance of a motor vehicle guided in an at least partially automated manner within a parking lot, using the system according to the first aspect, the method comprising the following steps:
ascertaining 301, by means of at least one of the first and second base units, infrastructure assistance data for infrastructure-based assistance of the motor vehicle guided in an at least partially automated manner within the parking lot, on the basis of the corresponding environment sensor data,
transmitting 303 the ascertained infrastructure assistance data to the motor vehicle by means of the at least one wireless communication interface.

In one embodiment the method comprises a step of ascertaining the corresponding area of the at least one environment sensor.

FIG. 4 shows a machine-readable storage medium 401, in which a computer program 403 is stored. The computer program 403 comprises instructions that, when the computer program 403 is executed by a computer, e.g., by the system according to the first aspect, cause the latter to perform a method according to the second aspect.

In summary, the concept is based on the use of an edge computing architecture in which a small number of environment sensors (e.g., 4 to 16) is connected to a base unit. Calculations, i.e., the ascertainment of the infrastructure assistance data, which are required for guiding the AVP motor vehicle in an at least partially automated manner are performed in a base unit located in the vicinity of the current motor vehicle position within the parking lot. This means that it is only necessary to collect environment sensor data from environment sensors in the vicinity of the base unit. This dramatically reduces the required network bandwidth.

It also eliminates the need for the central server(s) so that no server room is needed.

Base units are connected to adjacent base units in the form of a daisy chain. This makes it possible, if necessary, to collect environment sensor data from environment sensors connected to the adjacent base unit. By using a daisy chain instead of a tree topology, the wiring effort is reduced.

The complexity of the system is also reduced since only two types of hardware must be installed in the parking lot: environment sensors and base units.

Provided are, for example, environment sensors (e.g., cameras) that cover a portion of the driving path and are connected to a base unit arranged in this portion of the driving path.

For example, base units, which may also be in general referred to as computing units, are arranged along the driving path typically driven by the AVP motor vehicle. The base units are connected to their adjacent units along this driving path. At intersections or junctions where the AVP motor vehicle can take two or more different directions, the daisy chain also divides into two or more branches.

For example, it is provided that algorithms, in particular all algorithms needed in the infrastructure for controlling the AVP motor vehicle, are performed in a base unit that is located in the vicinity of the AVP motor vehicle, i.e., in the segment of the driving path on which the AVP motor vehicle is currently located. This dramatically reduces the network bandwidth.

For example, it is provided that each base unit comprises a wireless communication endpoint, the wireless communication interface, in order to directly communicate with the AVP motor vehicle. The communication can therefore advantageously take place only over short distances.

For example, a base unit comprises: a first network switch, which enables the connection to two or more adjacent base units; a second network switch, which makes it possible to connect all environment sensors, e.g., 8 environment sensors, as shown in FIG. 1, around the base unit to the latter; a computing device for performing algorithms, wherein the computing device, for example, comprises a standard x86 CPU, wherein the computing device, for example, comprises one or more processors; and a wireless communication interface, which is, for example, a WLAN access point, in order to enable a wireless connection to the AVP motor vehicle.

When the AVP motor vehicle is in the vicinity of a base unit, the base unit receives the environment sensor data from all environment sensors connected to it and, if necessary, also from the environment sensors connected to an adjacent base unit. In this case, this adjacent base unit transmits the corresponding environment sensor data to the base unit. However, it is never necessary to receive environment sensor data from an environment sensor that is further away, since the latter may not be relevant to the AVP motor vehicle. A high network bandwidth is therefore not needed.

Subsequently, the base unit locates the AVP motor vehicle on the basis of the environment sensor data. For example, the base unit detects free spaces on the basis of the environment sensor data, calculates a driving authorization for the motor vehicle, and transmits these infrastructure assistance data (information about free spaces, driving authorization) to the AVP motor vehicle via the wireless communication interface, e.g.,, the integrated WLAN access point.

When the AVP motor vehicle moves into the area of the next base unit, these tasks are handed over to the next base unit. Thus, the algorithms are always performed in a base unit in the vicinity of the AVP motor vehicle. This reduces network traffic and makes it possible to assist several AVP motor vehicles in parallel. Two AVP motor vehicles will always be so far apart that the calculations for driving the AVP motor vehicles can be carried out on different base units.

Since several base units are installed within the parking lot, there are sufficient base units to also enable redundant calculations, which are necessary to achieve the required safety integrity.

The base units, which are interconnected, form a daisy chain. The daisy chain is, for example, connected to follow the driving paths that an AVP motor vehicle can take in the parking lot. This means that, at intersections, the daisy chain also extends in more than two directions so that the AVP motor vehicle can drive in all directions at the intersection and can continue to be supported.

The daisy chain is, for example, also connected to the Internet. As a result, each base unit can connect to a backend, which makes remote monitoring and remote maintenance of the system possible.

In order to reduce current consumption, the base units may be put into an idle state and woken up again as needed. If a base unit sleeps, it, for example, also puts the connected environment sensors into the idle state. It does however ensure that the daisy chain is not interrupted during the sleep.

1-10. (canceled)

11. A system for infrastructure-based assistance of a motor vehicle guided in an at least partially automated manner within a parking lot, the system comprising:
a first base unit and a second base unit, which are arranged spaced apart from one another within the parking lot and are interconnected in series, wherein each respective base unit of the first base unit and the second base unit is respectively connected to at least one respective environment sensor that is arranged within the parking lot, in a respective environment of the respective base unit, and detects an area of the parking lot, wherein the first and second base units are respectively configured to ascertain respective infrastructure assistance data for infrastructure-based assistance of the motor vehicle guided in an at least partially automated manner within the parking lot, based on respective environment sensor data of the respective at least one environment sensor that represent the respective detected area; and
at least one wireless communication interface which is configured to transmit the ascertained infrastructure assistance data to the motor vehicle.

12. The system according to claim 11, wherein the first and second base units are respectively configured to ascertain the infrastructure assistance data based on the environment sensor data of the respective at least one environment sensor of the respectively other base unit.

13. The system according to claim 11, wherein the first and second base units respectively include a respective first communication device including a first network switch, and a respective second communication device including a second network switch, wherein a connection between the first and second base units is formed using the respective first communication devices of the first and second base units, and wherein a respective connection
